(19) United States
(12) Patent Application Publication
(10) Pub. No.: US 2022/0262249 A1
(43) Pub. Date: Aug. 18, 2022

(54) RESCHEDULING SYSTEM, RESCHEDULING METHOD, SCHEDULE PREDICTION SIMULATOR UNIT, RESCHEDULING DECISION UNIT, AND SET OF PROGRAMS FOR RESCHEDULING

(71) Applicant: Hitachi, Ltd., Tokyo (JP)

(72) Inventors: Yoshiharu HAYASHI, Tokyo (JP); Yoshinari HORI, Tokyo (JP); Takaaki SEKIAI, Tokyo (JP); Yasuharu NAMBA, Tokyo (JP)

(21) Appl. No.: 17/460,358

(22) Filed: Aug. 30, 2021

(30) Foreign Application Priority Data
Feb. 16, 2021 (JP) 2021-022472

(51) Int. Cl. G08G 1/127; G08G 1/00; G06N 3/08

(52) U.S. Cl. CPC G08G 1/127; G06N 3/08; G08G 1/202

(57) ABSTRACT

A rescheduling system performs rescheduling of passenger transports, some of which should be operated with priority and some of which should be operated ordinarily and includes a schedule prediction simulator unit adapted to create a forecast schedule in which a delay of a passenger transport has been incorporated into the planned schedule and create a modified schedule in which rescheduled objects in a timetable have been incorporated into the forecast schedule; and a rescheduling decision unit adapted to select passenger transports to be rescheduled using the planned schedule and the forecast schedule, determine the rescheduled objects in timetable with respect to the passenger transports to be rescheduled using a relationship between relative traveling positions of respective passenger transports, information relevant to advancing routes of the passenger transports, and other rescheduling history information, and give the determined rescheduled objects in the timetable to the schedule prediction simulator.

### CLAIM OF PRIORITY

The present application claims priority from Japanese Patent application serial No. 2021-022472, filed on Feb. 16, 2021, the content of which is hereby incorporated by reference into this application.

### BACKGROUND OF THE INVENTION

The present invention relates to a rescheduling system for passenger transports, a rescheduling method, a schedule prediction simulator unit, a rescheduling decision unit, and a set of programs for rescheduling with regard to rescheduling, i.e., replanning schedules in case disruption to services involving delays should happen with various kinds of passenger transports (such as trains, buses, and ships) that are operated according to service schedules.

Various kinds of passenger transports are trains, buses, ships and other traffic services. Among them, the following description takes trains for example. In case disruption to services should occur because of a train delay in service management of trains, rescheduling is performed to modify a planned schedule. For example, rescheduling is changing to a modified schedule allowing an express to overtake a local train at a station, which is unplanned, to prioritize the operation of the express. In addition, rescheduling mainly includes train service cancellation, partially cancelled operation, changing a turn-back station, etc.

Such rescheduling in most part relies on know-how in the present circumstances and, in most cases, operation commanders decide on rescheduling. Nevertheless, some systems adopt automation logics for rescheduling built in order to automate rescheduling. In an automation system for rescheduling, logics for rescheduling are described in advance in if-then terms or the like as a mapping relationship between delay conditions and rescheduling details. When a delay has occurred actually, a rescheduling decision is made based on these logics.

Automation technology mentioned above is often implemented based on a schedule prediction simulator by constraint programming. For example, according to Japanese Unexamined Patent Application Publication No. 2014-40161, a display is made to enable quick decision making of whether a train can arrive at its terminal station within a predetermined delay time, even if it is a little late. To increase the number of trains that can arrive at their terminal stations within the delay time, processing is configured to “manually change a planned schedule which has been set in advance, predict train operations of each train on the changed schedule to satisfy given constraint expressions, and create a forecast schedule with an acceptable delay time; furthermore, to change the train sequence between overtaking and overtaken trains, a station (an intersection point) where overtaking will occur, and tracks, thus changing each train schedule to reduce the number of trains that are delayed longer than the acceptable delay time, and present each train schedule obtained as a result to a user.”

Also, for example, Japanese Unexamined Patent Application Publication No. 2010-188750 discusses technology using patterns of user operation history upon disruption to services when train service has been disrupted. Because the technology suffers from problems such as lacking versatility of the patterns and time-consuming input operation by user for setting the patterns, processing is configured to, “by comparing a set of linked lines before and after being updated, generate a rule in if-then form in which conditional clauses describe a train operation delay and a train traveling route given by a scheduled line that is updated and execution clauses describe details of a change to the schedules of trains, apply the generated rescheduling rule to calculated schedule data, and carry out a schedule change described in the execution clauses for trains of interest, if there is a train operation delay satisfying the conditional clauses.”

### SUMMARY OF THE INVENTION

While it is possible to solve each particular problem according to the prior art references noted above, it is required to solve problems in the aspects of individual optimization and overall optimization in configuring a rescheduling automation system. In this regard, even though rescheduling is optimal for a rescheduled train (e.g., an express for which the rescheduling changes a station where it overtakes another train), the rescheduling also influences the schedules of trains that follow and, therefore, the rescheduling is not always optimal when viewed from the perspective of an overall whole day-long schedule. Therefore, a solution needs to be one that can accomplish comprehensive optimization of, e.g., train services over a long period such as a whole day, not only short-lived solutions.

Also, temporally variable disturbance has to be taken into consideration. In this regard, it is difficult to build logics for rescheduling that can respond to diverse conditions of disruption to services. Particularly, as an instance where a delay time changes over time, a temporally variable disturbance sometime occurs; e.g., an initially scheduled delay time will extend later. It is difficult to build logics, taking even such a disturbance into consideration.

From the foregoing, the present invention is intended to provide a rescheduling system, a rescheduling method, a schedule prediction simulator unit, a rescheduling decision unit, and a set of programs for rescheduling, enabling it to accomplish comprehensive optimization of, e.g., train services over a long period.

From the foregoing, one aspect of the present invention resides in a rescheduling system configured as follows: “a rescheduling system that performs rescheduling of passenger transports, some of which should be operated with priority and some of which should be operated ordinarily, in case a delay should occur in service of passenger transports operated according to a planned schedule, the rescheduling system including a schedule prediction simulator unit adapted to create a forecast schedule in which a delay of a passenger transport has been incorporated into the planned schedule and create a modified schedule in which rescheduled objects in timetable have been incorporated into the forecast schedule; and a rescheduling decision unit adapted to select passenger transports to be rescheduled using the planned schedule and the forecast schedule, determine the rescheduled objects in timetable with respect to the passenger transports to be rescheduled using a relationship between relative traveling positions of respective passenger transports, information relevant to advancing routes of the passenger transports, and other rescheduling history information, and give the determined rescheduled objects in timetable to the schedule prediction simulator.”

Another aspect of the present invention resides in a rescheduling method configured as follows: “a rescheduling method that performs rescheduling of passenger transports, some of which should be operated with priority and some of which should be operated ordinarily, in case a delay should occur in service of passenger transports operated according to a planned schedule, the rescheduling method including the steps of creating a forecast schedule in which a delay of a passenger transport has been incorporated into the planned schedule and creating a modified schedule in which rescheduled objects in timetable have been incorporated into the forecast schedule; selecting passenger transports to be rescheduled using the planned schedule and the forecast schedule; and determining the rescheduled objects in timetable with respect to the passenger transports to be rescheduled using a relationship between relative traveling positions of respective passenger transports, information relevant to advancing routes of the passenger transports, and other rescheduling history information.”

Another aspect of the present invention resides in a prediction simulator unit configured as follows: “a prediction simulator unit for rescheduling of passenger transports, some of which should be operated with priority and some of which should be operated ordinarily, in case a delay should occur in service of passenger transports operated according to a planned schedule, the prediction simulator unit being adapted to create a forecast schedule in which a delay of a passenger transport has been incorporated into the planned schedule and create a modified schedule in which rescheduled objects in timetable have been incorporated into the forecast schedule. The prediction simulator unit outputs the planned schedule and the forecast schedule and obtains the rescheduled objects in timetable. The rescheduled objects in timetable are determined through a process including selecting passenger transports to be rescheduled using the planned schedule and the forecast schedule and determining the rescheduled objects in timetable with respect to the passenger transports to be rescheduled using a relationship between relative traveling positions of respective passenger transports, information relevant to advancing routes of the passenger transports, and other rescheduling history information.”

Another aspect of the present invention resides in a rescheduling decision unit configured as follows: “a rescheduling decision unit for rescheduling of passenger transports, some of which should be operated with priority and some of which should be operated ordinarily, in case a delay should occur in service of passenger transports operated according to a planned schedule. The rescheduling decision unit selects passenger transports to be rescheduled using the planned schedule and a forecast schedule in which a delay of a passenger transport has been incorporated into the planned schedule, determines rescheduled objects in timetable with respect to the passenger transports to be rescheduled using a relationship between relative traveling positions of respective passenger transports, information relevant to advancing routes of the passenger transports, and other rescheduling history information, and supplies the rescheduled objects in timetable that will be incorporated into the forecast schedule in a process of creating a modified schedule.”

Another aspect of the present invention resides in a set of programs for rescheduling configured as follows: “a set of programs for rescheduling to be provided in ROM for rescheduling of passenger transports, some of which should be operated with priority and some of which should be operated ordinarily, using a computer, in case a delay should occur in service of passenger transports operated according to a planned schedule, the set of programs for rescheduling including a program for a schedule prediction simulator, the program being adapted to create a forecast schedule in which a delay of a passenger transport has been incorporated into the planned schedule and create a modified schedule in which rescheduled objects in timetable have been incorporated into the forecast schedule; and programs for making rescheduling decision adapted to select passenger transports to be rescheduled using the planned schedule and the forecast schedule and determine the rescheduled objects in timetable with respect to the passenger transports to be rescheduled using a relationship between relative traveling positions of respective passenger transports, information relevant to advancing routes of the passenger transports, and other rescheduling history information.”

According to the present invention, it is possible to provide a train service rescheduling system and a method therefore making it possible to accomplish comprehensive optimization of, e.g., train services over a long period.

### BRIEF DESCRIPTION OF THE DRAWINGS

FIG. 1 is a diagram depicting a schematic configuration example of a rescheduling system pertaining to a first embodiment of the present invention;

FIG. 2 is a diagram representing an example of a planned schedule P1 created based on inputs;

FIG. 3 is a diagram representing an example of a forecast schedule P2;

FIG. 4 is a diagram representing an example of a modified schedule P3;

FIG. 5 is a diagram illustrating an overall processing flow in the rescheduling system comprised of a schedule prediction simulator unit 20 and a rescheduling decision unit 30;

FIG. 6 is a diagram illustrating a concrete processing flow to be carried out by a train selecting unit 31;

FIG. 7 is a diagram illustrating a processing flow in the rescheduling system provided with reinforcement learning functionality;

FIG. 8 is a diagram representing an example of a track constraint or track assignment D2;

FIG. 9 is a diagram representing an example of a stop time constraint D3;

FIG. 10 is a diagram representing an example of a traveling time constraint D4;

FIG. 11 is a diagram representing an example of track assignment data;

FIG. 12 is a diagram tabulating processing outputs of processing steps S35 and S36;

FIG. 13 is a diagram representing a relationship between the travel time until arrival and the delay time of a priority train and a local train at candidate stations;

FIG. 14 is a diagram representing an example of rescheduling history data stored in a rescheduling history storage unit DB1;

FIG. 15 is a diagram illustrating an example of how to determine actions in Deep Q-Network (DQN) reinforcement learning;

FIG. 16 is a diagram illustrating that an individual output of a neuron is obtained as the sum of the products of inputs and weight coefficients that are given to the neuron;

FIG. 17 is a diagram representing a case where multiple trains are rescheduled; and

FIG. 18 is a diagram depicting a schematic configuration example of a rescheduling system pertaining to a third embodiment of the present invention.

### DETAILED DESCRIPTION OF THE PREFERRED EMBODIMENTS

Embodiments of the present invention are described below with the aid of drawings.

A first embodiment discusses a schematic configuration example of a rescheduling system pertaining to the present invention and a rescheduling method. A second embodiment discusses incorporating a learning function. A third embodiment discusses coping with multiple delay events. A fourth embodiment discusses programs that are provided in ROM when a rescheduling system is configured with a computer.

### First Embodiment

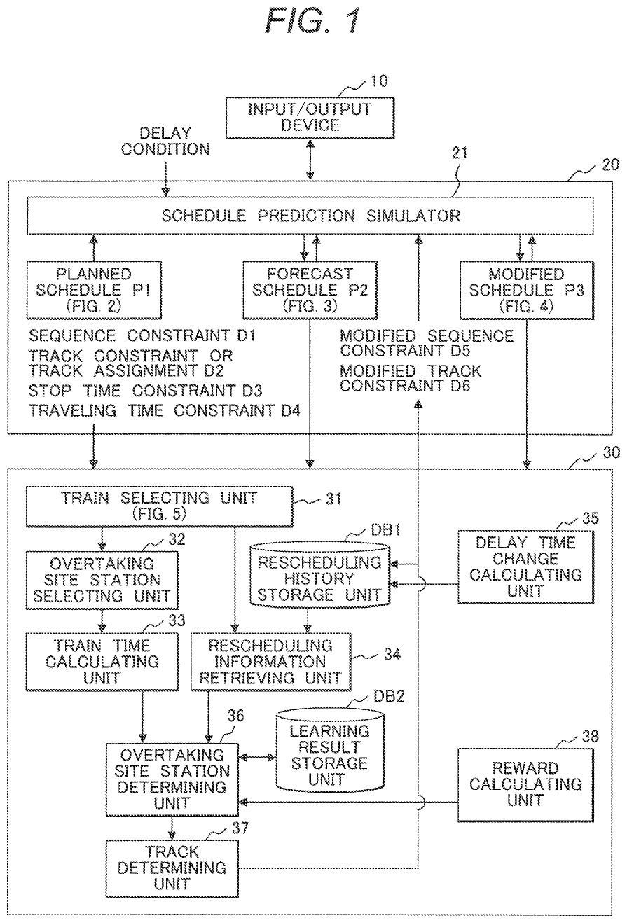

The first embodiment of the present invention is described with the aid of drawings. First, FIG. 1 depicts a schematic configuration example of a rescheduling system pertaining to the present invention. The rescheduling system that is configured using a computer is comprised of main components as follows: an input/output device 10, a schedule prediction simulator unit 20, and a rescheduling decision unit 30. Note that the schedule prediction simulator unit 20 and the rescheduling decision unit 30 may be configured in a single integral computer or in separate computers interconnected via a network.

One implementation of the present invention resides in a rescheduling system for proposing and carrying out rescheduling of passenger transports, some of which should be operated with priority and some of which should be operated ordinarily, in case a delay should happen with the passenger transports operated according to a planned schedule. Here, the passenger transports are trains, busses, ships, and other traffic services. In an example discussed below, trains are taken for example and descriptions are provided assuming that passenger transports to be operated with priority are expresses (or priority trains) and passenger transports to be operated ordinarily are local trains.

First, the input/output device 10 is configured including output means such as a printer and a monitor and input means such as a keyboard. For example, what is input to it includes, inter alia, arrival/departure times of each train at each station and assigned tracks as schedule information for scheduling passenger transports, e.g., trains; the order of stations, distance between stations, and track assignment information (e.g., a track number that is assigned to an up(inbound)-line train) as station information; and delay conditions. These inputs are given to the schedule prediction simulator unit 20 and the rescheduling decision unit 30. What can be acquired as an output includes a planned schedule P1, a forecast schedule P2, and a modified schedule P3.

The schedule prediction simulator unit 20 has a schedule prediction simulator 21 as a principal component. This unit handles a planned schedule P1, a forecast schedule P2, and a modified schedule P3, and the schedule prediction simulator 21 makes an evaluation based on a constraint programming algorithm. Its concrete implementation method is described in Japanese Unexamined Patent Application Publication No. 2014-40161 among others and, therefore, detail description about it is not provided herein.

Among the abovementioned schedules, a planned schedule P1 is an initially planned service schedule of passenger transports. Service is performed by this planned schedule unless any disturbance or cause of a change occurs in passenger transports. A planned schedule P1 is determined in compliance with various constraint conditions created based on the abovementioned inputs (except for delay conditions). These constraint conditions, which will be detailed later, are, for example, a sequence constraint D1, a track constraint or track assignment D2, a stop time constraint D3, a traveling time constraint D4, and other information. Note that a planned schedule P1 that is created based on the inputs from the input/output device 10 may be retained in a database which is not depicted or may be taken in from outside via a network and the input/output device 10.

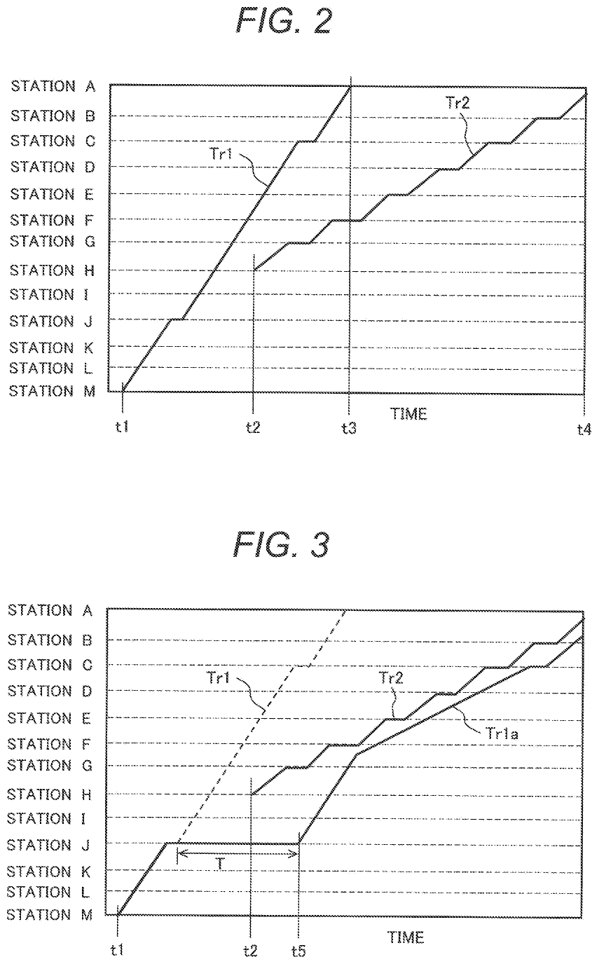

FIG. 2 is a diagram representing an example of the planned schedule P1 created based on the inputs. In this example, as indicated by a scheduled line Tr1 of an express, the express is operated, scheduled to leave its starting station M at time t1, stop at stations J and C, and then arrive at its terminal station A at time t3. On the other hand, as indicated by a scheduled line Tr2 of a local train, the local train is operated, scheduled to leave its starting station H at time t2, stop at each station, and then arrive at its terminal station A at time t4. According to this planned schedule P1 created initially, the express is always operated in advance of the local train and, therefore, the sequence between them is not reversed.

This planned schedule P1 is that created in accordance with the constraint conditions as follows: the sequence constraint D1 regarding train departure sequence at each station; the track constraint or track assignment D2 indicating a track assigned to a train at each station; the stop time constraint D3 representing a minimum time interval for which a train stops at each station, the train being either a local train or an express; and the traveling time constraint D4 denoting minimum traveling time, i.e., an upper limit of speed of a train moving from one station to another, the train being either a local train or an express.

The constraint conditions in the example representing the planned schedule P1 in FIG. 2 are further detailed.

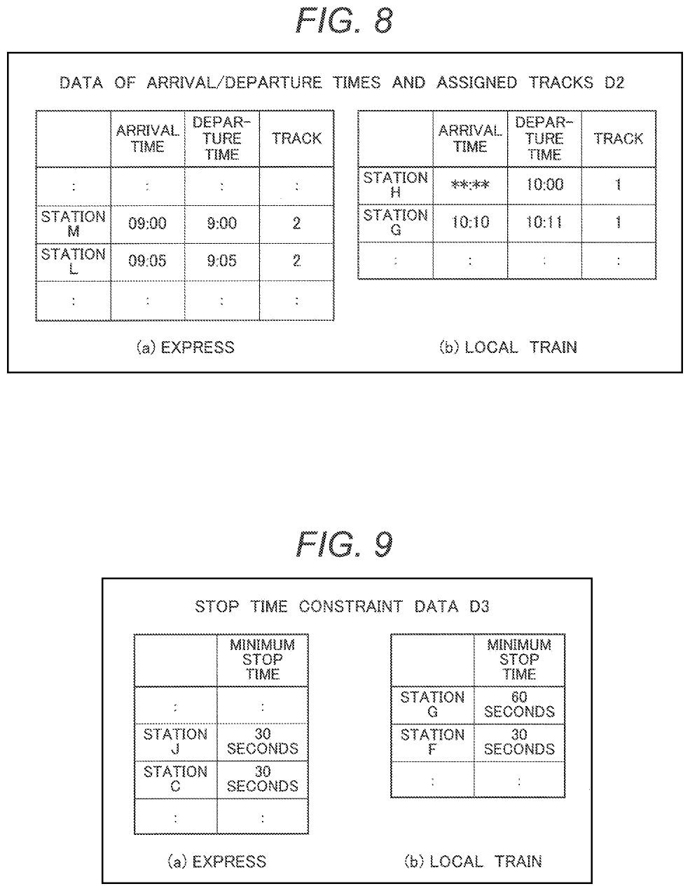

As for the sequence constraint D1 regarding the train departure sequence at each station, data of departure/arrival times at stations that a train passes through (all stations from the station M to the station A in the case of an express and all stations from the station H to the station A in the case of a local train) is described in time series, as exemplified in FIG. 8. Thereby it can be decided that the express is earlier than the local train in terms of the train departure sequence at each station from the station H to the station A.

As for the track constraint or track assignment D2 indicating tracks assigned to trains at each station, data of tracks assigned to a train at the stations that the train pass through, the train being either an express or a local train, is described in time series, as also exemplified in FIG. 8.

As for the stop time constraint D3 representing a minimum time interval for which a train stops at each station, the train being either a local train or an express, data of the minimum time interval for which a train stops at stations (stations J, C, and A in the case of an express and all stations from the station G to the station A in the case of a local train), the train being either an express or a local train, is described in time series, as exemplified in FIG. 9.

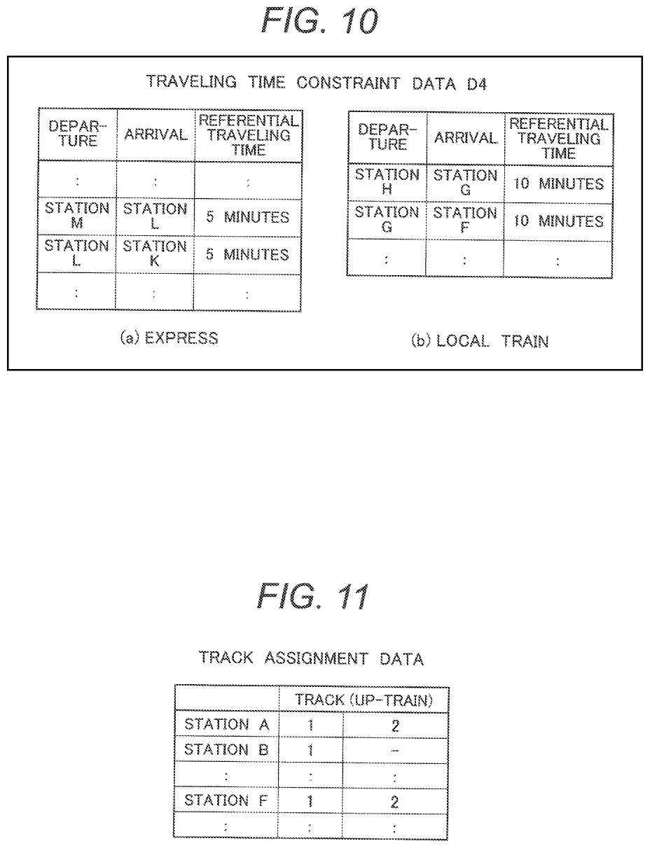

As for the traveling time constraint D4 denoting minimum traveling time, i.e., an upper limit of speed of a train moving from one station to another, the train being either a local train or an express, referential traveling time of a train moving between departure and arrival stations is described, the train being either an express or a local train, as exemplified in FIG. 10. The planned schedule P1 is created to comply with these constraint conditions.

As a premise for creating these schedules, the system has track number assignment data regarding tracks at each station. This is, for example, as exemplified in FIG. 11 and the numbers of tracks available at each station by up/down (inbound/outbound) classification are described and stored. In the example of FIG. 11, the stations A and F have two tracks, numbers 1 and 2, as up(inbound)-train tracks, whereas the station b has only one track, number 1. Note that, naturally, a station allowing one train to overtake another train there needs to have a track for waiting and a track for passage.

FIG. 3 is a diagram representing an example of a forecast schedule P2 in which a delay condition setting has been set and incorporated into the planned schedule P1. A delay condition here is given by specifying a train and a station and setting a delay time or specifying a section (from a station to a station) and setting a condition to apply for the section such as operation suspension or slow down.

In the example of FIG. 3, although the scheduled line of the express should be a dotted line Tr1 originally, a situation arises where the express, once stopped at the station J, cannot move off there even after the elapse of a stop time because of, e.g., emergency inspection. By input of a delay condition, it is revealed that a delay of time T from the original departure time has occurred or is anticipated to occur.

At this point of time, the schedule prediction simulator unit 20 creates the forecast schedule P2 as is in FIG. 3 with the input of a delay condition form the input/output device 10. According to the forecast schedule P2 with the delay condition incorporated therein, the express can leave the station J at time t5, but the operation sequence between the express and the local train is reversed because the local train has already leaved its starting station H at the time t5. If no measures are taken, leaving it as it is, the express will be operated to travel later than the preceding local train with a delay increasing, as indicated by a scheduled line Tr1a. Therefore, the forecast schedule P2 indicates a situation arising for which any rescheduling should be performed.

In the rescheduling procedure, generally any one or multiple actions should be determined from among options as follows: a departure sequence change, a track change, train service cancellation, partially cancelled operation, changing a turn-back station, or taking no action. Where such actions should apply and personnel who execute them should be determined as a rescheduling plan.

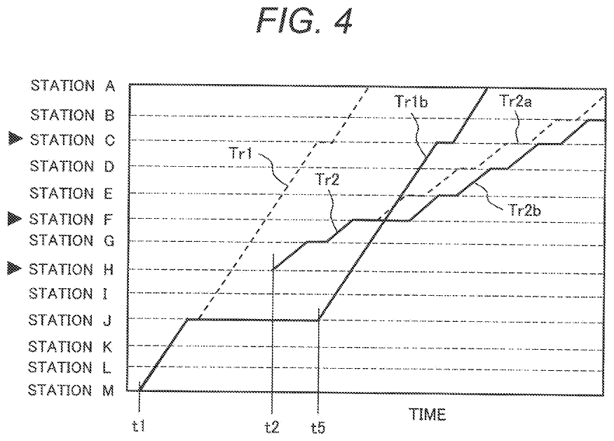

FIG. 4 is a diagram representing an example of a modified schedule P3 in which rescheduled objects in timetable given by a rescheduling plan have been set and incorporated into the forecast schedule P2. In the example of FIG. 4, since the express has delayed by the delay time T at the station J, deviating from the originally scheduled line Tr1, the express is restarted at time t5 to follow a new scheduled line Tr1b involving the delay time T incorporated into the originally scheduled line Tr1. Namely, in this example, a departure sequence change and a track change are determined in a rescheduling plan and the rescheduled objects in timetable are intended to prioritize the operation of the express. Accordingly, the local train is scheduled to wait at the station F having multiple tracks, deviating from its originally scheduled line Tr2a, and scheduled to restart after passage of the express, following a new scheduled line Tr2b.

The schedule prediction simulator unit 20 in FIG. 1 creates a planned schedule P1 using the input data, creates a forecast schedule P2 by setting delay conditions and incorporating them into the planned schedule P1, and obtains a modified schedule P3 by setting rescheduled objects in timetable and incorporating them into the forecast schedule P2. When obtaining the modified schedule P3, the schedule prediction simulator unit 20 gives the planned schedule P1 and the forecast schedule P2 to the rescheduling decision unit 30 and receives modified constraint conditions (for rescheduled objects in timetable) to determine the modified schedule P3.

Returning to FIG. 1, the rescheduling decision unit 30 includes processing units as follows: a train selecting unit 31; an overtaking site station candidate selecting unit 32; a train time calculating unit 33; a rescheduling information retrieving unit 34; an overtaking site station determining unit 36; a track determining unit 37; a delay time change calculating unit 35; and a reward calculating unit 38. The rescheduling decision unit 30 is also provided with databases: a rescheduling history storage unit DB1; and a learning result storage unit DB2.

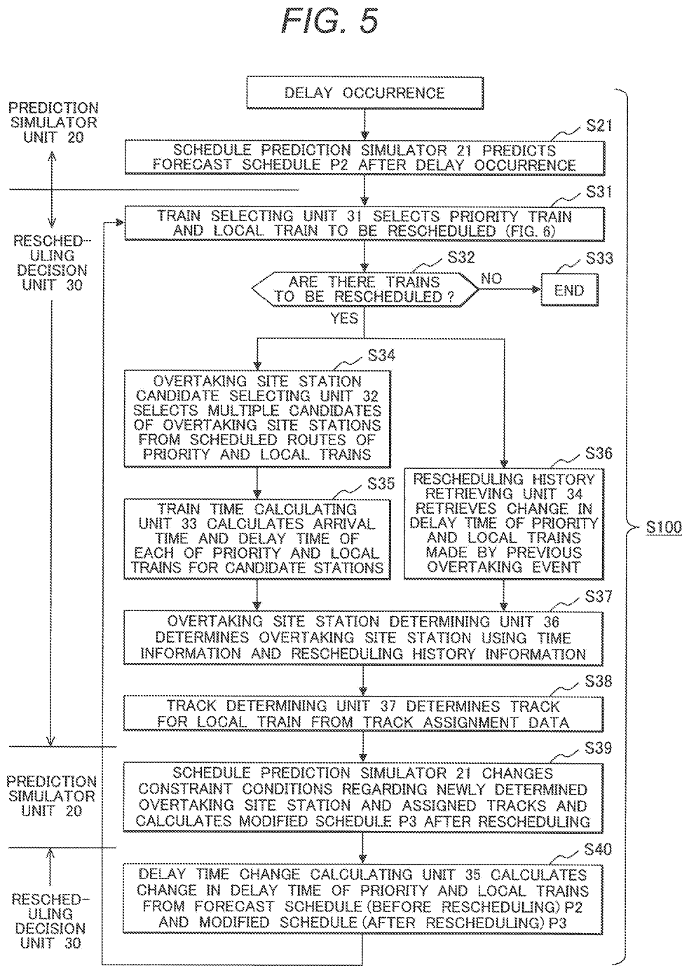

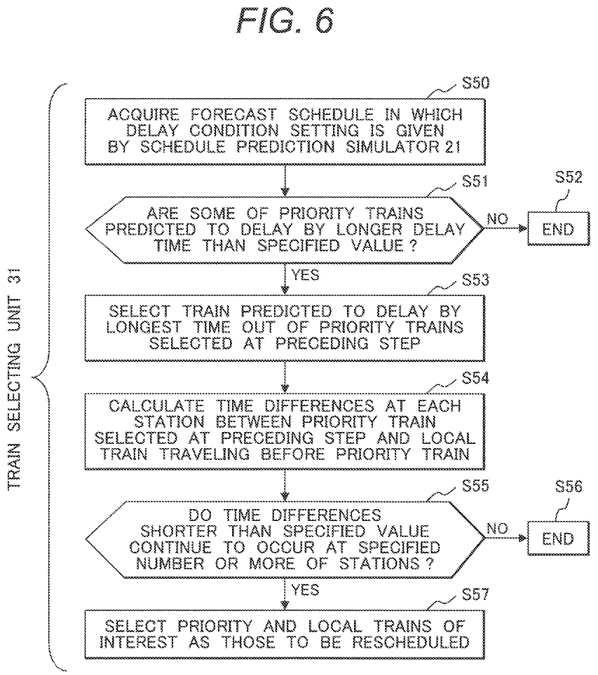

Processing flows in which the processing functions in the rescheduling system of FIG. 1 are carried out by a computer are described with FIGS. 5 and 6. These processing flows illustrate a rescheduling method of the present invention. First, FIG. 5 illustrates an overall processing flow in the rescheduling system comprised of the schedule prediction simulator unit 20 and the rescheduling decision unit 30. This processing is to start, triggered by delay occurrence as a start condition.

In FIG. 5, a first processing step S21 is executed by the schedule prediction simulator 21. The schedule prediction simulator 21 predicts scheduling of trains after delay occurrence and obtains a forecast schedule P2. Processing steps S31 to S38 are executed in the rescheduling decision unit 30. At a first processing step S31 in the rescheduling decision unit 30, the train selecting unit 31 selects a priority train and a local train to be rescheduled.

FIG. 6 illustrates a concrete processing flow to be carried out by the train selecting unit 31. First, a processing step S50 is to acquire a forecast schedule P2 in which a delay condition setting is given by the schedule prediction simulator 21. Then, a processing step S51 is to decide whether some of priority trains (expresses correspond to them) are predicted to delay by a longer delay time than a specified value. For instance, in a case where a train delay even if having occurred is insignificant in time and trains can be operated without having a large impact on a planned schedule P1 created initially, a decision is made that no trains are predicted to delay by a longer delay time than the specified value and a transition is made to a processing step S52; subsequent processing is not performed.

If one or more trains are predicted to delay by a longer delay time than the specified value, a transition is made to a processing step S53; this step is to select a train predicted to delay by the longest time out of the priority trains selected at the processing step S51. As for the example discussed previously, a train selected at this step is the express stopped at the station J for emergency inspection.

A processing step S54 is to calculate time differences at each station between the priority train selected and a local train traveling before the priority train. This processing is performed for the forecast schedule P2. Referring to FIG. 3, the step calculates time differences at each station between the scheduled line Tr1a of the priority train and the schedule line Tr2 of the local train traveling before the priority train.

A processing step S55 is to decide whether time differences shorter than a specified value continue to occur at a specified number or more of stations. Here, the time differences shorter than the specified value indicate that the selected priority train is almost catching up the local train traveling before it. This state that continues to occur at a specified number or more of stations indicates that the priority train almost catching up the local train continues to travel, just following the local train. However, in some cases, the priority train is almost catching up the local train, but this state occurs at stations less than the specified number of stations. This means that the local train traveling before the priority train has come to a point near to its terminal station A. Both the trains may be operated up to the terminal station A in the unchanged departure sequence without making the priority train overtake the local train. In this case, a transition is made to a processing step S56 and subsequent processing may not be performed.

A processing step S57 is to select the priority and local trains of interest as those to be rescheduled because the time differences shorter than the specified value between both the trains continue to occur at the specified number of more of stations. Thereby, referring to the forecast schedule P2 in FIG. 3, the priority train scheduled by the line Tr1a and the local train scheduled by the line Tr2 are selected. Note that, when all trains to be rescheduled can be extracted, a more optimal outcome can be achieved.

Returning to the overall flow in FIG. 5, a processing step S32 is to verify that there are the trains selected as those to be rescheduled. If there are not those trains, a transition is made to a processing step S33 and subsequent processing is not performed. In this case, the priority train scheduled by the line Tr1a and the local train scheduled by the line Tr2 are selected, and the processing branches into a processing step S34 and a processing step S36 which are executed in parallel.

At the processing step S34, the overtaking site station candidate selecting unit 32 selects multiple candidates of overtaking site stations from the scheduled routes of the priority and local trains. In this case, stations C, F, and H marked with black triangles in the modified schedule P3 of FIG. 4 are selected as the candidates. Note that, for this selection, by reference to the track assignment data in FIG. 11, stations having multiple tracks, where a track for waiting and a track for passage are available, can be found as the candidates of overtaking site stations.

Subsequently, at a processing step S35, the train time calculating unit 33 calculates the travel time until arrival and delay time of each of the priority and local trains for the candidate stations (stations C, F, and H). When calculating the travel time until arrival and delay time, reference is made to schedules data output by the schedule prediction simulator, as shown in FIGS. 2 to 4. On the other hand, at the processing step S36, the rescheduling information retrieving unit 34 retrieves a change in delay time of the priority and local trains made by a previous overtaking event.

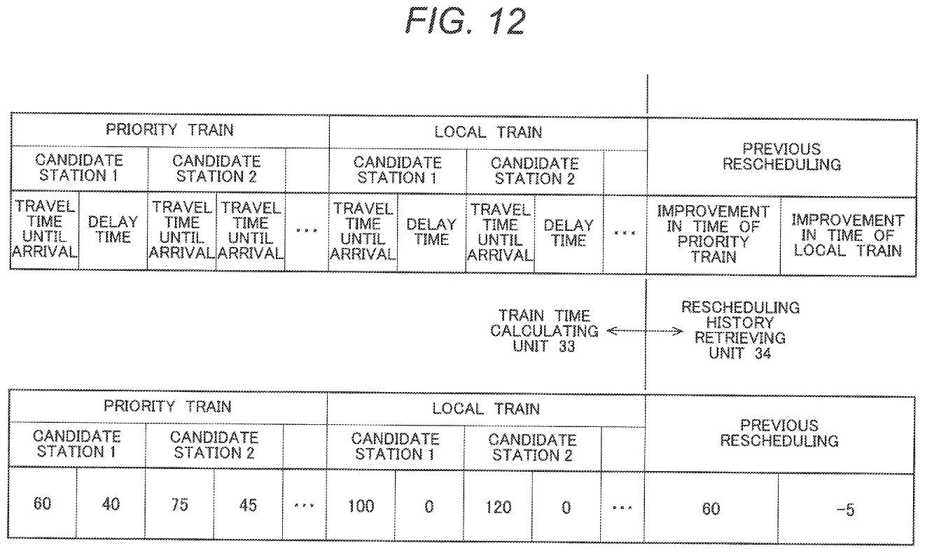

FIG. 12 is a list tabulating outputs from the processing in the processing steps S35 and S36, the list in an upper row presenting what outputs are defined in the table and the list in a lower row presenting examples of concrete time values of the respective outputs. A left part of this table lists and describes the travel time until arrival and delay time of the priority and local trains at each candidate station, which are pieces of information output by the train time calculating unit 33. A right part of the table lists and describes improvement in time of the priority train and improvement in time of the local train upon a previous rescheduling event, which are pieces of information output by the rescheduling information retrieving unit 34.

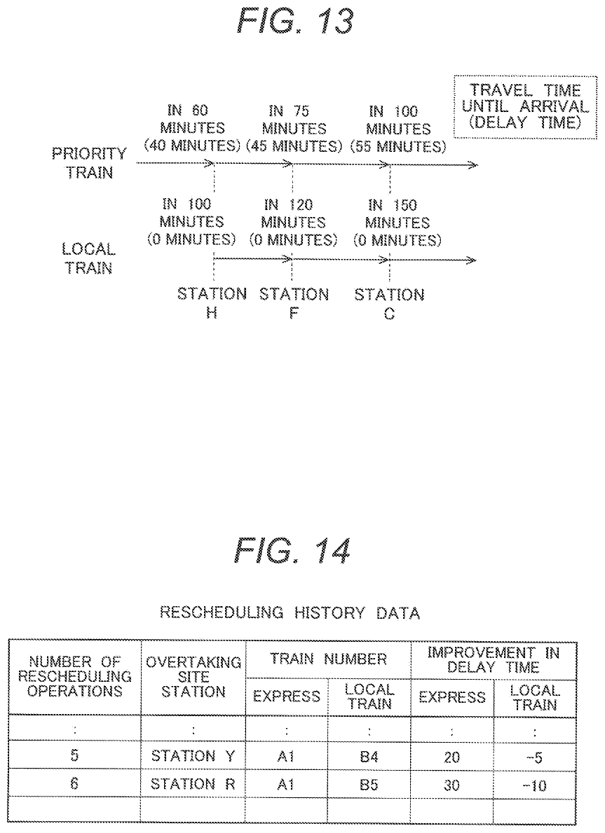

In this case, candidate station 1 is the station H and candidate station 2 is the station F. Also, in the example shown as the forecast schedule P2 of FIG. 3, the time values given in the lower row are assigned to the travel time until arrival and delay time of each train at each station. A relationship between the travel time until arrival and the delay time is represented in an each-to-understand manner in FIG. 13. It can be understood that, if the trains are operated as scheduled by the lines Tr2 and Tr1a in the forecast schedule P2 of FIG. 3, the local train will not experience a delay time, but the priority train will delay longer as it arrives at a candidate station that is more distant. In an example of the table (lower row) of FIG. 12, a result of a rescheduling event performed previously is described. The outcome of the previous rescheduling event shows that the time of the priority train improved to 60 minutes, whereas the local train experienced a delay of five minutes because of waiting for being overtaken by the priority train.

At a processing step S37, the overtaking site station determining unit 36 determines an overtaking site station using time information and rescheduling history information. In this case, the station F is determined to be optimal as the overtaking site for the express restarted from the time t5 to overtake the local train.

At a processing step S38, the track determining unit 37 refers to track assignment data in FIG. 11 and determines a track for the local train from this data. Since the station F has up(inbound)-train tracks, number 1 and number 2, for instance, track 2 is assigned for the express to pass for overtaking the local train and track 1 is assigned for the local train to wait. Results of decisions that have been made here are passed to the schedule prediction simulator 21 as modified constraints. The contents of the modified constraints include a modified sequence constraint that means changing the sequence of the trains and a modified track constraint that means changing the track assignment at a station when the sequence change is performed.

At a processing step S39 in the schedule prediction simulator unit 20, the schedule prediction simulator 21 changes the constraint conditions regarding the newly determined overtaking site station and assigned tracks and calculates a modified schedule P3 after rescheduling.

Subsequently, at a processing step S40 within the rescheduling decision unit 30, the delay time change calculating unit 35 calculates a change in delay time of the priority and local trains from the forecast schedule P2 (before rescheduling) and the modified schedule P3 (after rescheduling) and stores results of the calculation into the rescheduling history storage unit DB1. For instance, taking TDi to stand for the delay time of the priority train and TDj to stand for the delay time of the local train, a change in delay time before and after rescheduling is calculated as ΔTDi and ΔTDj respectively. Note that the thus calculated data as rescheduling history is used as previous rescheduling history shown in FIG. 12. ΔTDi is shown as improvement in time of the priority train and ΔTDj is shown as improvement in time of the local train in FIG. 12. When a rescheduling plan is intended for overtaking, ΔTDi is a positive value indicating time reduction, whereas ΔTDj is a negative value meaning an increase in time as an extension time for waiting.

FIG. 14 is a diagram representing an example of rescheduling history data stored in the rescheduling history storage unit DB1. Since, in most cases, countermeasures for delay elimination can be achieved by combination of multiple rescheduling operations, a record of rescheduling history data includes a set of correlated data below: the number of rescheduling operations; an overtaking site station; the numbers identifying the priority and local trains, improvement in time per train by the rescheduling; etc.

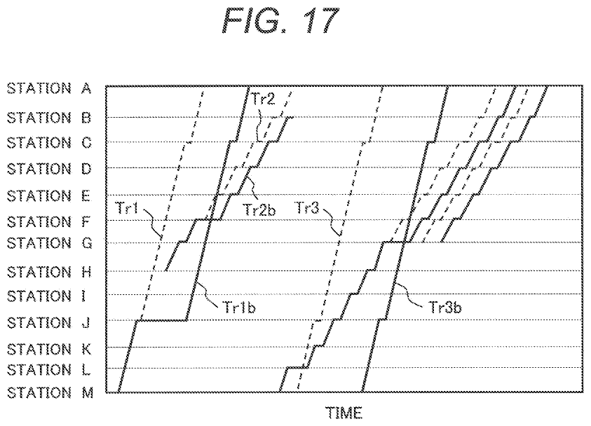

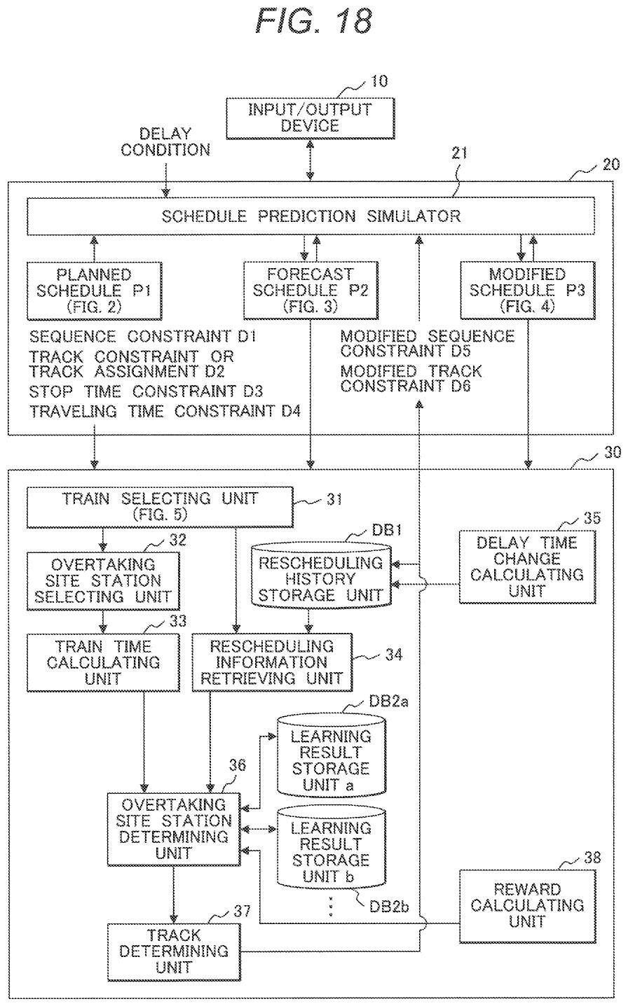

Note that, in the modified schedule P3 shown in FIG. 4, rescheduling that targets one train is only illustrated to make the processing flow easy to understand. However, rescheduling that targets multiple trains is often carried out in practical cases of delay. For example, as shown in FIG. 17, an evaluation is made of a modified schedule in which rescheduling (overtaking actions) targeting multiple trains is carried out and it is intended to optimize rescheduling aiming at delay improvement throughout the schedule. Selection of a train (express) that overtakes another train and a train (local) that is overtaken is as described with FIG. 6. Trains selected through the described processing are to be rescheduled.

According to the rescheduling system described in the first embodiment described hereinbefore, it is possible to accomplish comprehensive optimization of, e.g., train services over a long period such as a whole day. This is feasible by selecting trains to be rescheduled and proposing and executing rescheduling plans for all selected trains.

### Second Embodiment

The rescheduling system pertaining to the first embodiment of the present invention is basically configured as depicted in FIG. 1 and basically executes the processing flows of FIGS. 5 and 6. In this basic configuration, prior learning with delay conditions that are varied is performed according to a second embodiment of the present invention.

Prior learning in the rescheduling system is to learn in advance relationships between rescheduling and delay improvement in diverse conditions of disruption to services based on a reinforcement learning algorithm, using the schedule prediction simulator 21.

In this process, learning data is created by the schedule prediction simulator 21. This data is obtained by changing a train that causes a delay, its position (station), and a delay time to simulate diverse conditions of disruption to services. Moreover, data including a temporal change in a delay state is also used, which is obtained by changing a delay time over time. Using learning data created through the above process, rescheduling plans that make delay improvement optimal are learned in advance. Then, an effect of delay improvement is evaluated with respect to multiple trains involved in rescheduling. In another aspect of operation, when a delay has occurred actually, the actually occurred delay state is input to the system and the system outputs a rescheduling plan using learning results.

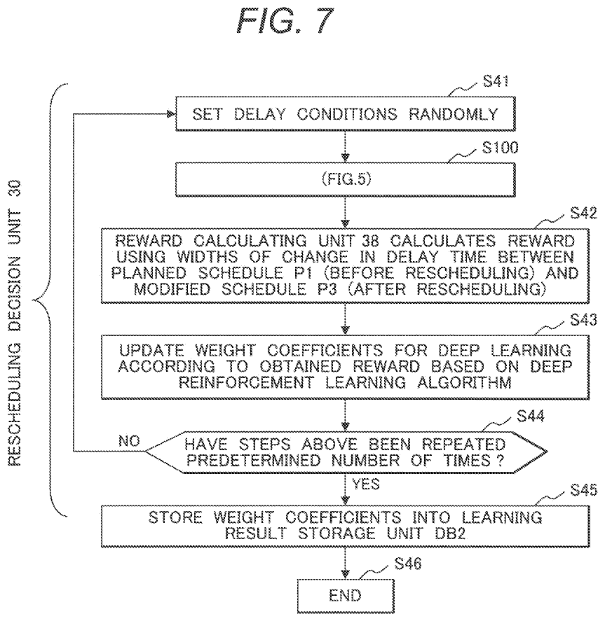

FIG. 7 is a diagram illustrating a processing flow in the rescheduling system provided with reinforcement learning functionality. A processing step 100 in a second row from top in FIG. 7 corresponds to the contents of processing illustrated in FIG. 5 which is performed by the schedule prediction simulator unit 20 and the rescheduling decision unit 30. For execution of reinforcement learning, the flow of FIG. 7 includes new processing steps S41 to S46 with repeated execution of the flow of FIG. 5.

Before describing the flow of FIG. 7, the concept of the reinforcement learning functionality and how it is applied to the rescheduling system will be described below.

First, the concept of the reinforcement learning functionality is described. Three keywords of reinforcement learning are state, action, and reward. In plain words, state is input data, action is output data, and reward is KPI (key performance indicator). Here, one of actions corresponding to state data is determined to give the greatest (optimal) reward in one episode. Specifically, outputs are the action values of optional actions for a state that is input. According to a reinforcement learning algorithm, an action value represents an expected value of reward that is gained in the future. An action having the greatest action value is determined to be optimal for the state. Note that Deep Q-Network (DQN) reinforcement learning is assumed to be used in the present embodiment. DQN is a reinforcement learning calculation method utilizing neural nets. An action value function (input is a state and outputs are the action values of actions) is approximated by a neural net.

Then, how the reinforcement learning functionality is applied to the rescheduling system is described. Input data for application of the reinforcement learning functionality to the rescheduling system is as follows: schedule information (arrival/departure times of each train at each station and assigned tracks) and station information (the order of stations, distance between stations, and track assignment information such as a track number that is assigned to an up(inbound)-line train), as mentioned previously. Moreover, the input data determined from the abovementioned pieces of information is as follows: the sequence constraint D1 (train departure sequence at each station); the track constraint D2 (a track assigned to a train at each station); the stop time constraint D3 (a minimum time interval for which a train stops at each station, the train being either a local train or an express); the traveling time constraint D4 (minimum traveling time, i.e., an upper limit of speed of a train moving from one station to another, the train being either a local train or an express); and others such as minimum traveling time (distance) between trains.

When the reinforcement learning functionality is applied to the rescheduling system, output data is as follows: a planned schedule P1, a forecast schedule P2, and a modified schedule P, as mentioned previously. Furthermore, a reward is a rescheduling plan that makes delay improvement optimal and it is needed for this to determine an overtaking site station.

More briefly speaking, the schedule prediction simulator 21 combined with reinforcement learning mentioned above determines, e.g., an “overtaking site station” by reinforcement learning according to the present embodiment. A state (input) for this processing is information required to calculate the travel time until arrival and delay time at candidates of overtaking site stations for both of a train A (express) that overtakes another train and a train B (local) that is overtaken. Action (output) is determining an overtaking site station. A reward is determined from the widths of a change in delay time (ΔTDi and ΔTDj) of each train throughout the schedule before and after rescheduling.

Rescheduling to allow a priority train to overtake a local train is not always performed for one pair of priority and local trains. Other trains traveling before and after those trains also need to be taken in consideration. Multiple candidates of overtaking site stations should be selected subject to the following conditions: a station exists in the advancing routes of the priority and local trains; and a station has a track for overtaking. Information required for rescheduling (unplanned overtaking) is an overtaking site station, a priority train and a local train, and tracks. Among them, tracks should be determined based on “track assignment information”.

In the processing flow of FIG. 7, a first processing step S41 is to set delay conditions randomly to run a reinforcement learning process. This step appropriately varies a place where a delay has occurred, time when the delay occurred, and a delayed train among others and sets them sequentially. Upon input of such delay conditions, a modified schedule P3 is shown through a series of processing steps S100 illustrated to be performed by the rescheduling system in FIG. 1.

Then, at a processing step S42, the reward calculating unit 38 calculates a reward using the widths of a change in delay time (ΔTDi and ΔTDj) between the planned schedule P1 (before rescheduling) and the modified schedule P3 (after rescheduling). This reward corresponds to improvement in time of the priority train and the local train by the rescheduling.

More specifically speaking, first, a total value ΣΔTDi of the widths of a change in delay time ΔTDi of all priority trains before and after rescheduling is calculated as “a” and a total value ΣΔTDj of the widths of a change in delay time ΔTDj of all local trains before and after rescheduling is calculated as “b”. Note that “a” becomes positive (a≥0), if rescheduling has improved the priority train delay time. However, the local train delay time may extend because of waiting for being overtaken by a priority train. Consequently, “b” becomes negative (b≤0). In addition, taking A to stand for a total value ΣTDi of the delay times TDi of all priority trains before rescheduling, Equation (1) is calculated, where w is weight, 0≤w≤1, and 0≤R0≤1.

[Equation 1]

R0=(a+wb)/A (1)

R0 in Equation (1) represents an improvement rate of delay of priority trains with local train delay extension taken into account. A threshold r is set for R0. R=R0 when R0≥r and R=−P when R0<r, where 0≤r≤1 and −P≤0. R denotes a reward of reinforcement learning. Larger R indicates a larger reward, i.e., a larger effect of improvement is obtained by rescheduling. The threshold setting r is provided for regarding quite a low rate of improvement, even though it is positive, as a negative reward. A negative reward R means that little effect of improvement is obtained by rescheduling or some deterioration results and that rescheduling should not be performed positively.

Then, a processing step S43 is to update weight coefficients for deep learning according to the obtained reward based on a deep reinforcement learning algorithm. At a processing step S44, a series of processing steps above is executed repeatedly a predetermined number of times with delay condition settings being varied. When the series of steps has been executed the predetermined number of times, finally, a processing step S45 is to store the weight coefficients into the learning result storage unit DB2.

Here, an explanation is provided about processing details of “updating weight coefficients for deep learning according to the obtained reward based on a deep reinforcement learning algorithm” at the processing step S43, based on a deep reinforcement learning theory.

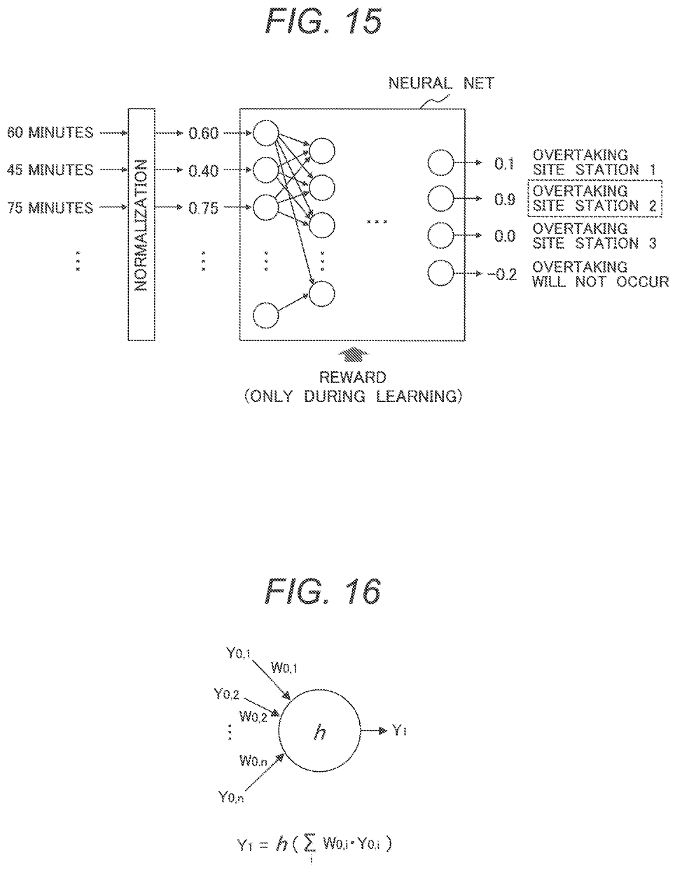

In Deep Q-Network (DQN) reinforcement learning, deep learning neural nets are used. FIG. 15 illustrates an example of how to determine actions in DQN reinforcement learning. Here, input to a neural net is multidimensional data that represents a state and the neural net receives N-dimensional setting data. When the neural net is applied to the rescheduling system, normalized train delay information can be used. On the other hand, outputs of the neural net are the action values of actions. When the neural net is applied to the rescheduling system, overtaking site stations where one train will overtake another are output as the action values. In the example of FIG. 15, M options of the actions that can be taken are set (the M options are stations 1, 2, and 3 as overtaking site stations plus an option that no overtaking will occur). Among the M optional actions, an action having the greatest actin value is determined to be optimal.

Also, during learning, weight coefficients for the neural net are determined by convergence calculation to obtain the greatest cumulative reward. FIG. 16 illustrates that an individual output of a neuron is obtained as the sum of the products of inputs and weight coefficients that are given to the neuron. The weight coefficients are adjusted through the learning process so that the action value function will be approximated by the neural net.

The foregoing learning process is performed with multiple conditions that have been set in advance. However, when a delay has been occurred actually in the services of passenger transports, actually occurred delay conditions are input and a rescheduling plan can be output using learning results.

According to the rescheduling system described in the second embodiment described hereinbefore, it is possible to accomplish comprehensive optimization of, e.g., train services over a long period such as a whole day. This is feasible by using neural nets for reinforcement learning that is adopted to this embodiment and intended for comprehensive optimization of rewards until final state, instead of short-lived optimization.

### Third Embodiment

Rescheduling trains to allow an express to overtake a local train is discussed in the first embodiment with the assumption that trains are classified into two priority levels; express and local train. However, in some routes, trains may be classified into three or more levels of priority: e.g., express, rapid train, and local train. In this case, it is conceivable that an optimal overtaking site station where an express will overtake a local train differs from such a station where a rapid train will overtake a local train.

The present invention is applicable for this case. Learning results can be stored with respect to each of different priority levels of trains in separate learning result storage units DB2a and DB2b, for example, as depicted in FIG. 18. For instance, reference should be made to DB2a to retrieve data relevant to an express and reference should be made to DB2b to retrieve data relevant to a rapid train.

### Fourth Embodiment

In a fourth embodiment, when the rescheduling system is implemented using a computer that is comprised of ROM, RAM, CPU, etc. interconnected via a bus, programs that are provided in the ROM are described. Programs that should be provided in the ROM are as follows: a program for the schedule prediction simulator to implement functionality of the schedule prediction simulator unit 20; and programs for making rescheduling decision regarding the rescheduling decision unit 30. A set of rescheduling decision programs includes: a program for selecting trains to implement functionality of the train selecting unit 31; a program for selecting candidates of overtaking site stations to implement functionality of the overtaking site station candidate selecting unit 32; a program for calculating train time to implement functionality of the train time calculating unit 33; a program for retrieving rescheduling information to implement functionality of the rescheduling information retrieving unit 34; a program for determining an overtaking site station to implement functionality of the overtaking site station determining unit 36; a program for determining tracks to implement functionality of the track determining unit 37; a program for calculating a delay time change to implement functionality of the delay time change calculating unit 35; and a program for calculating rewards to implement functionality of the reward calculating unit 38.

### REFERENCE SIGNS LIST

10: input/output device
20: schedule prediction simulator unit
21: schedule prediction simulator
30: rescheduling decision unit
31: train selecting unit
32: overtaking site station candidate selecting unit
33: train time calculating unit
34: rescheduling information retrieving unit
36: overtaking site station determining unit
37: track determining unit
35: delay time change calculating unit
38: reward calculating unit
DB1: rescheduling history storage unit
DB2: learning result storage unit
P1: planned schedule
P2: forecast schedule
P3: modified schedule

What is claimed is:

1. A rescheduling system that performs rescheduling of passenger transports, some of which should be operated with priority and some of which should be operated ordinarily, in case a delay should occur in service of passenger transports operated according to a planned schedule, the rescheduling system comprising:
a schedule prediction simulator unit adapted to create a forecast schedule in which a delay of a passenger transport has been incorporated into the planned schedule and create a modified schedule in which rescheduled objects in timetable have been incorporated into the forecast schedule; and
a rescheduling decision unit adapted to select passenger transports to be rescheduled using the planned schedule and the forecast schedule, determine the rescheduled objects in timetable with respect to the passenger transports to be rescheduled using a relationship between relative traveling positions of respective passenger transports, information relevant to advancing routes of the passenger transports, and other rescheduling history information, and give the determined rescheduled objects in timetable to the schedule prediction simulator.

2. The rescheduling system according to claim 1, wherein the rescheduling decision unit performs reinforcement learning that, with respect to variably set conditions of the delay, determines the rescheduled objects in timetable under each delay condition, and calculates a reward using a delay time change between the forecast schedule and the modified schedule.

3. The rescheduling system according to claim 2, wherein the reinforcement learning is performed in a phase before a passenger transport actually experiences a delay and, when a passenger transport has actually experienced a delay, the rescheduled objects in timetable are determined using results of the reinforcement learning.

4. The rescheduling system according to claim 1, wherein the passenger transports may be trains, buses, or ships and, if the passenger transports are trains, passenger transports which should be operated with priority are priority trains and passenger transports which should be operated ordinarily are local trains.

5. The rescheduling system according to claim 4, wherein, if the passenger transports are trains, the priority trains include multiple sorts of trains having different levels of priority.

6. The rescheduling system according to claim 5, wherein the rescheduled objects in timetable pertain to overtaking, turn-back, and train service cancellation and include an option of taking no action.

7. The rescheduling system according to claim 2,
wherein inputs to a reinforcement learning process are the travel time until arrival and delay time of a passenger transport which should be operated with priority and a passage transport which should be operated ordinarily at overtaking site candidates where overtaking between both the passage transports is predicted to occur, and history of rescheduling;
the reinforcement learning process calculates rewards from a change in the delay times of the passenger transport which should be operated with priority and the passage transport which should be operated ordinarily before and after rescheduling; and
an output of the reinforcement learning process is selected from the overtaking site candidates and the option of taking no action.

8. A rescheduling method that performs rescheduling of passenger transports, some of which should be operated with priority and some of which should be operated ordinarily, in case a delay should occur in service of passenger transports operated according to a planned schedule, the rescheduling method comprising the steps of:
creating a forecast schedule in which a delay of a passenger transport has been incorporated into the planned schedule and creating a modified schedule in which rescheduled objects in timetable have been incorporated into the forecast schedule;
selecting passenger transports to be rescheduled using the planned schedule and the forecast schedule; and
determining the rescheduled objects in timetable with respect to the passenger transports to be rescheduled using a relationship between relative traveling positions of respective passenger transports, information relevant to advancing routes of the passenger transports, and other rescheduling history information.

9. The rescheduling method according to claim 8, wherein the method is adapted to perform reinforcement learning that, with respect to variably set conditions of the delay, determines the rescheduled objects in timetable under each delay condition and calculates a reward using a delay time change between the forecast schedule and the modified schedule.

10. The rescheduling method according to claim 9, wherein the reinforcement learning is performed in a phase before a passenger transport actually experiences a delay and, when a passenger transport has actually experienced a delay, the rescheduled objects in timetable are determined using results of the reinforcement learning.

11. A prediction simulator unit for rescheduling of passenger transports, some of which should be operated with priority and some of which should be operated ordinarily, in case a delay should occur in service of passenger transports operated according to a planned schedule, the prediction simulator unit being adapted to create a forecast schedule in which a delay of a passenger transport has been incorporated into the planned schedule and create a modified schedule in which rescheduled objects in timetable have been incorporated into the forecast schedule,
wherein the prediction simulator unit outputs the planned schedule and the forecast schedule and obtains the rescheduled objects in timetable, and
wherein the rescheduled objects in timetable are determined through a process including selecting passenger transports to be rescheduled using the planned schedule and the forecast schedule and determining the rescheduled objects in timetable with respect to the passenger transports to be rescheduled using a relationship between relative traveling positions of respective passenger transports, information relevant to advancing routes of the passenger transports, and other rescheduling history information.

12. A rescheduling decision unit for rescheduling of passenger transports, some of which should be operated with priority and some of which should be operated ordinarily, in case a delay should occur in service of passenger transports operated according to a planned schedule,
wherein the rescheduling decision unit selects passenger transports to be rescheduled using the planned schedule and a forecast schedule in which a delay of a passenger transport has been incorporated into the planned schedule, determines rescheduled objects in timetable with respect to the passenger transports to be rescheduled using a relationship between relative traveling positions of respective passenger transports, information relevant to advancing routes of the passenger transports, and other rescheduling history information, and supplies the rescheduled objects in timetable that will be incorporated into the forecast schedule in a process of creating a modified schedule.

13. A set of programs for rescheduling to be provided in ROM for rescheduling of passenger transports, some of which should be operated with priority and some of which should be operated ordinarily, using a computer, in case a delay should occur in service of passenger transports operated according to a planned schedule, the set of programs for rescheduling comprising:
a program for a schedule prediction simulator, the program being adapted to create a forecast schedule in which a delay of a passenger transport has been incorporated into the planned schedule and create a modified schedule in which rescheduled objects in timetable have been incorporated into the forecast schedule; and
programs for making rescheduling decision adapted to select passenger transports to be rescheduled using the planned schedule and the forecast schedule and determine the rescheduled objects in timetable with respect to the passenger transports to be rescheduled using a relationship between relative traveling positions of respective passenger transports, information relevant to advancing routes of the passenger transports, and other rescheduling history information.
